(19) United States
(12) Patent Application Publication
(10) Pub. No.: US 2026/0350994 A1
(43) Pub. Date: Nov. 5, 2026

(54) SALES FLOOR MANAGEMENT SYSTEM AND SALES FLOOR MANAGEMENT METHOD

(71) Applicant: PANASONIC INTELLECTUAL PROPERTY MANAGEMENT CO., LTD., Osaka (JP)

(72) Inventor: Takeshi WATANABE, Kanagawa (JP)

(73) Assignee: PANASONIC INTELLECTUAL PROPERTY MANAGEMENT CO., LTD., Osaka (JP)

(21) Appl. No.: 19/150,449

(22) PCT Filed: Jan. 16, 2024
(86) PCT No.: PCT/JP2024/000980

§ 371 Date: Jul. 23, 2025

(30) Foreign Application Priority Data
Jan. 27, 2023 (JP) 2023-010684

(51) Int. Cl. G06V 20/50; G05D 1/689; G05D 105/70; G05D 107/60; G06Q 30/0601; G06T 11/00; G06V 10/70

(52) U.S. Cl. CPC G06V 20/50; G06Q 30/0639; G06T 11/00; G06V 10/70; G05D 1/689; G05D 2105/70; G05D 2107/67

(57) ABSTRACT

Provided is a sales floor management system for managing a display state of products on a sales floor of a store based on a captured image acquired from a camera 1 for imaging the sales floor that can achieve a display state of products in a sales floor of a store that can provide a good appearance of the products to customers and ensure high recognition accuracy of a product recognition model. The system comprises: a server that performs operations including using a product recognition model to recognize products from the captured image (product recognition operation), based on the recognition result, generating display support information for supporting display work performed by a user (display support information generation operation), and presenting the display support information to the user, wherein the server generates, as the display support information, information on a recommended display state of target products.

### TECHNICAL FIELD

The present disclosure relates to a sales floor management system and a sales floor management method for managing a display state of products on a sales floor of a store based on a captured image acquired from a camera for imaging the sales floor.

### BACKGROUND ART

In retail stores such as convenience stores, when there are inappropriate states in the display of merchandise items (hereafter referred to as “products”) on the sales floor; that is, when products are displayed in a disorderly manner or are missing, opportunity loss occurs, which can significantly affect store sales. Therefore, when there are inappropriate states in the display of products, it is necessary to promptly carry out display work (rearranging and/or replenishing) to correct the inappropriate states.

Known technologies related to such display work include a system configured such that, when detecting inappropriate display states based on results of product identification and store shelf identification, the system generates a monitoring screen in which a frame image surrounding an area in which inappropriate display states occur is overlaid on a sales floor image (Patent Document 1). This system enables quick and appropriate instructions to correct inappropriate display states based on captured images of a sales floor, such as unexpected situations where there are products that are not intended for display.

### PRIOR ART DOCUMENT(S)

### Patent Document(s)

Patent Document 1: JP6751882B

### SUMMARY OF THE INVENTION

### Task to be Accomplished by the Invention

In the prior art, the system uses machine-learning-based object recognition technology to recognize products on store shelves and detect situations where there are products that are not intended for display (i.e., products that have not been used for machine learning), as inappropriate display states. However, even when there is not any product that is not intended for display, a situation in which some products are arranged inconsistently and randomly, can cause problems that the appearance of the products to customers is spoiled and the accuracy of a machine-learning-based product recognition model is affected. For example, when a product is displayed upside down, product recognition fails, and the system cannot appropriately detect a missing state of the product.

The present disclosure has been made in view of the problem of the prior art, and a primary object of the present disclosure is to provide a sales floor management system and a sales floor management method that enable achievement of a display state of products in a sales floor of a store that can provide a good appearance of the products to customers and ensure high recognition accuracy of a product recognition model.

### Means to Accomplish the Task

An aspect of the present disclosure provides a sales floor management system for managing a display state of products on a sales floor of a store based on a captured image acquired from a camera for imaging the sales floor, comprising: an information processing device that performs operations including: using a product recognition model to recognize products from the captured image; based on the recognition result, generating display support information for supporting display work performed by a user; and presenting the display support information to the user, wherein the operations performed by the information processing device include generating, as the display support information, information on a recommended display state of target products.

Another aspect of the present disclosure provides a sales floor management method in which an information processing device is caused to perform operations for managing a display state of products on a sales floor of a store based on a captured image acquired from a camera for imaging the sales floor, wherein the operations performed by the information processing device include: using a product recognition model to recognize products from the captured image; based on the recognition result, generating, as display support information for supporting display work performed by a user, information on a recommended display state of target products; and presenting the display support information to the user.

### Effect of the Invention

According to the present disclosure, a system or a method presents to a user (e.g., a store personnel) a recommended display state of products as display support information, which enables the user to perform display work so as to re-arrange the products into the recommended display state. This enables achievement of a display state of products in a sales floor of a store that can provide a good appearance of the products to customers and ensure high recognition accuracy of a product recognition model.

### BRIEF DESCRIPTION OF THE DRAWINGS

FIG. 1 is a diagram showing an overall configuration of a sales floor management system according to a first embodiment of the present disclosure;

FIG. 2 is an explanatory diagram showing an overview of the sales floor management system of the first embodiment;

FIG. 3 is a block diagram showing a schematic configuration of a server of the first embodiment;

FIG. 4 is an explanatory diagram showing a screen displayed on a user terminal of the first embodiment when the display state of a product is a missing state;

FIG. 5 is an explanatory diagram showing a screen displayed on the user terminal of the first embodiment when the display state of product is an inappropriate display state;

FIG. 6 is an explanatory diagram showing a screen displayed on the user terminal of the first embodiment when the display state of product is the inappropriate display state;

FIG. 7 is an explanatory diagram showing a screen displayed on the user terminal of the first embodiment when the display state of product is the inappropriate display state;

FIG. 8 is a block diagram showing an overview of operations performed by the server of the first embodiment when the display state of a product is the missing state;

FIG. 9 is a block diagram showing an overview of operations performed by the server of the first embodiment when the display state of a product is another inappropriate display state;

FIG. 10 is a block diagram showing an overview of operations performed by the server of the first embodiment when the display state of a product is yet another inappropriate display state;

FIG. 11 is a flow chart showing a procedure of operations performed by the server of the first embodiment;

FIG. 12 is a diagram showing an overview of a sales floor management system according to a variant of the first embodiment of the present disclosure;

FIG. 13 is a diagram showing an overview of a sales floor management system according to a second embodiment of the present disclosure; and

FIG. 14 is a block diagram showing an overview of operations performed by a server of the second embodiment when the display state of a product is the missing state.

### DESCRIPTION OF THE PREFERRED EMBODIMENT(S)

As a solution to the above-described tasks to be accomplished, a first aspect of the present disclosure provides a sales floor management system for managing a display state of products on a sales floor of a store based on a captured image acquired from a camera for imaging the sales floor, comprising: an information processing device that performs operations including: using a product recognition model to recognize products from the captured image; based on the recognition result, generating display support information for supporting display work performed by a user; and presenting the display support information to the user, wherein the operations performed by the information processing device include generating, as the display support information, information on a recommended display state of target products.

According to this configuration, the system presents to a user (e.g., a store personnel) a recommended display state of products as display support information, which enables the user to perform display work so as to re-arrange the products into the recommended display state. This also enables achievement of a display state of products in a sales floor of a store that can provide a good appearance of the products to customers and ensure high recognition accuracy of a product recognition model.

A second aspect of the present disclosure is the above system configured such that the operations performed by the information processing device include, when detecting a missing state based on the captured image, generating, as the display support information, information that notifies the user of a position of a display area that is in the missing state, and presenting the recommended display state of products to the user.

This configuration enables the user to quickly recognize the missing state of products and appropriately perform display work so as to re-arrange the products into the recommended display state.

A third aspect of the present disclosure is the above system configured such that the recommended display state is a display state in which a product recognition score output from the product recognition model is equal to or greater than a predetermine reference value.

This configuration enables achievement of a display state of products that can ensure high recognition accuracy of the product recognition model. Information on the recommended display state may be preset for each of the products and recorded in a product management database.

A fourth aspect of the present disclosure provides a sales floor management system for managing a display state of products on a sales floor of a store based on a captured image acquired from a camera for imaging the sales floor, comprising: an information processing device that performs operations including: using a product recognition model to recognize products from the captured image; based on the recognition result, generating display support information for supporting display work performed by a user; and presenting the display support information to the user, wherein the operations performed by the information processing device include, based on the recognition result, detecting an inappropriate display state of a product; and generating, as the display support information, information on a position of the product that is in the inappropriate display state.

This configuration presents to the user a position of the product that is in the inappropriate display state, which enables the user to quickly perform display work so as to remedy the inappropriate display state.

A fifth aspect of the present disclosure is the above system configured such that the operations performed by the information processing device include, when detecting an inappropriate display state of a product, generating, as the display support information, information that notifies the user of a position of the product that is in the inappropriate display state, and presenting the recommended display state of the product to the user.

This configuration enables the user to quickly identify a product that is in the inappropriate display state and appropriately perform display work such that the product is displayed in the recommended display state.

A sixth aspect of the present disclosure is the above system configured such that the operations performed by the information processing device include detecting the inappropriate display state of a product based on a product recognition score output from the product recognition model.

This configuration enables appropriate detection of the recommended display state of a product. In this case, the system may determine that the product is in the inappropriate display state when the product recognition score therefor is lower than the predetermined reference value.

A seventh aspect of the present disclosure is the above system configured such that the operations performed by the information processing device include generating, as the display support information, an image that visualizes a level of appropriateness of the display state of a product.

This configuration enables the user to easily grasp the appropriateness of the display state of a product.

An eighth aspect of the present disclosure is the above system configured to further comprise a display device possessed by the user, wherein the display support information is presented to the user via the display device.

In this configuration, the system can appropriately present display support information to the user.

A ninth aspect of the present disclosure is the above system configured such that the display device displays the display support information as a virtual object overlaid on a real space within the user's actual field of view.

In this configuration, the system can present to the user display support information in such a manner as to enable the user to easily identify the information. In this case, the display device may display an image representing products in the recommended display state as virtual objects, and an image representing products in the inappropriate display state as virtual objects. In some cases, the display device may be a wearable device that is worn on the user's head and implements AR (augmented reality) or MR (mixed reality).

A tenth aspect of the present disclosure is the above system configured to further comprise a robot that performs display work, wherein the robot is configured to: acquire, as the display support information, information on a recommended display state of target products from the information processing device; and perform display work based on the display support information.

This configuration enables the robot to perform display work such that products are displayed in an appropriate display state.

An eleventh aspect of the present disclosure is the above system configured such that the operations performed by the information processing device include generating the display support information based on information on the camera for imaging the sales floor, including the camera's installation position, imaging angle and relative position to a display area to be imaged.

In this configuration, the system can generate appropriate display support information.

A twelfth aspect of the present disclosure provides a sales floor management method in which an information processing device is caused to perform operations for managing a display state of products on a sales floor of a store based on a captured image acquired from a camera for imaging the sales floor, wherein the operations performed by the information processing device include: using a product recognition model to recognize products from the captured image; based on the recognition result, generating, as display support information for supporting display work performed by a user, information on a recommended display state of target products; and presenting the display support information to the user.

This configuration enables achievement of a display state of products in a sales floor of a store that can provide a good appearance of the products to customers and ensure high recognition accuracy of a product recognition model, in the same manner as the first aspect.

A thirteenth aspect of the present disclosure provides a sales floor management method in which an information processing device is caused to perform operations for managing a display state of products on a sales floor of a store based on a captured image acquired from a camera for imaging the sales floor, wherein the operations performed by the information processing device include: using a product recognition model to recognize products from the captured image; based on the recognition result, detecting an inappropriate display state of a product; generating, as display support information for supporting display work performed by a user, information on a position of the product that is in the inappropriate display state; and presenting the display support information to the user.

This configuration presents to the user a position of the product that is in the inappropriate display state, which enables the user to quickly perform display work so as to remedy the inappropriate display state, in the same manner as the fourth aspect.

Embodiments of the present disclosure will be described below with reference to the drawings.

### First Embodiment

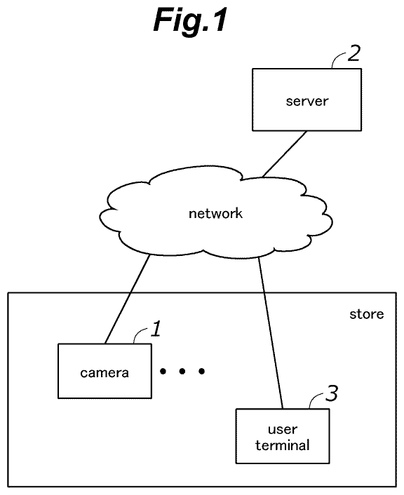

FIG. 1 is a diagram showing an overall configuration of a sales floor management system according to a first embodiment of the present disclosure.

The system manages a display state of products in a sales floor. The system includes at least one camera 1, a server 2 (information processing device, sales floor management device), and at least one user terminal 3 (display device). The camera 1 and the user terminal 3 are connected to the server 2 via a network.

The camera 1 is installed at an appropriate location in the store and images (i.e., acquires captured images of) a sales floor therein.

The server 2 receives captured images transmitted from the camera 1, manages a display state of products in the sales floor based on the captured images, and transmits to the user terminal 3 display support information for assisting display work performed by a user (such as a store personnel).

The user terminal 3 is a mobile device such as a tablet device or smartphone, and is to be carried by a user. The user terminal 3 presents display support information received from server 2 to a user.

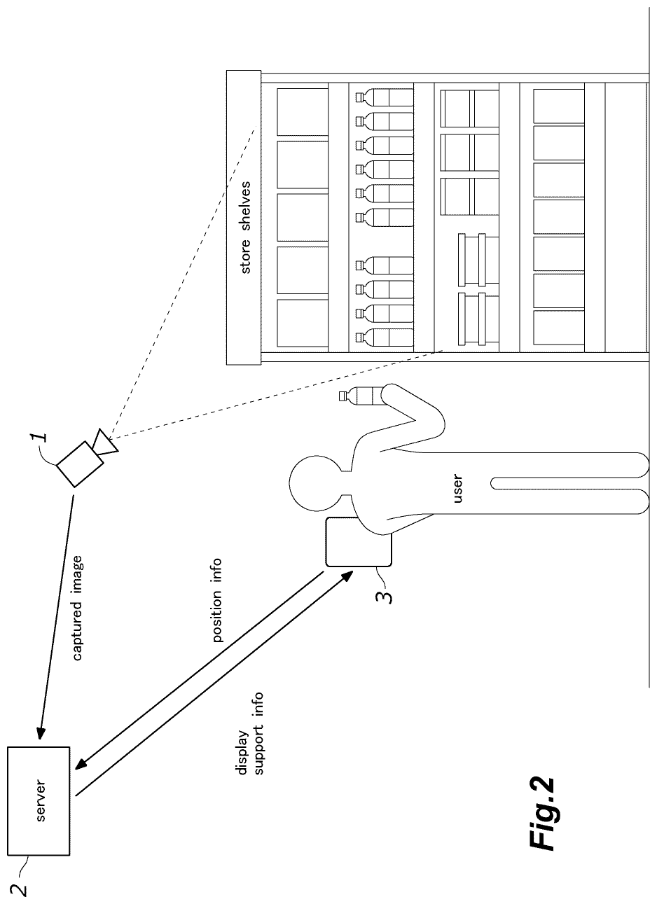

Next, an overview of the sales floor management system of the first embodiment will be described. FIG. 2 is an explanatory diagram showing an overview of the sales floor management system.

The camera 1 images store shelves (display area) installed in the sales floor of the store and transmits captured images to the server 2. Various products are displayed on the store shelves. In FIG. 2, a display area of a target product is store shelves. However, the display area may be various types of display fixtures such as display stands or carts.

The user terminal 3 acquires position information including its position determined by indoor positioning and transmits the position information to the server 2.

The server 2 acquires the position of a target store shelf (display area) based on the position information from the user terminal 3, which represents the current position of a user.

Then, the server 2 recognizes the product displayed on the store shelf based on captured images received from the camera 1, which is used to image the store shelf. This product recognition operation uses a product recognition model (machine learning model) constructed by using machine learning technology such as deep learning. Next, the server 2 detects a missing state of the store shelf, i.e., the state in which one or more products are missing from the store shelf (degree of shortage, e.g., 80% missing products ratio), based on the recognition results of the product recognition operation. Furthermore, the server 2 detects one or more products in an inappropriate display state, i.e., products in the display state that is significantly different from a recommended display state, based on the recognition results of the product recognition operation.

Specifically, the recommended display state is a display state of products in a sales floor of a store that can provide a good appearance of the products to customers and ensure high recognition accuracy of a product recognition model. The recommended display state is preset for each product. In addition, the appearance of products in captured images, which affects the recognition accuracy of the product recognition model, varies depending on the relative position of the store shelf (display area) to the camera 1. Thus, the recommended display state of products may be determined according to the display position of a product on the store shelf in order to ensure high recognition accuracy for the product recognition model.

Next, the server 2 generates display support information that assists a user's display work. Next, the server 2 displays a screen presenting the display support information on the user terminal 3. Specifically, the user terminal 3 displays a screen that provides a notification of detection of the missing state (missing alert), presents a recommended display state for the detected product in the missing state, as well as providing a notification of detection of the inappropriate display state (inappropriate display alert), and presenting a recommended display state for the detected product in the inappropriate display state.

When the store shelf is in the missing state (i.e., the missing state of a product occurs on that store shelf), the screen indication allows a user to perform work so as to remedy the missing state; that is, to replenish products. When the display state on the store self is the inappropriate display state, the screen indication allows the user to perform work so as to remedy the inappropriate display state; that is, to re-arrange the products into the appropriate state.

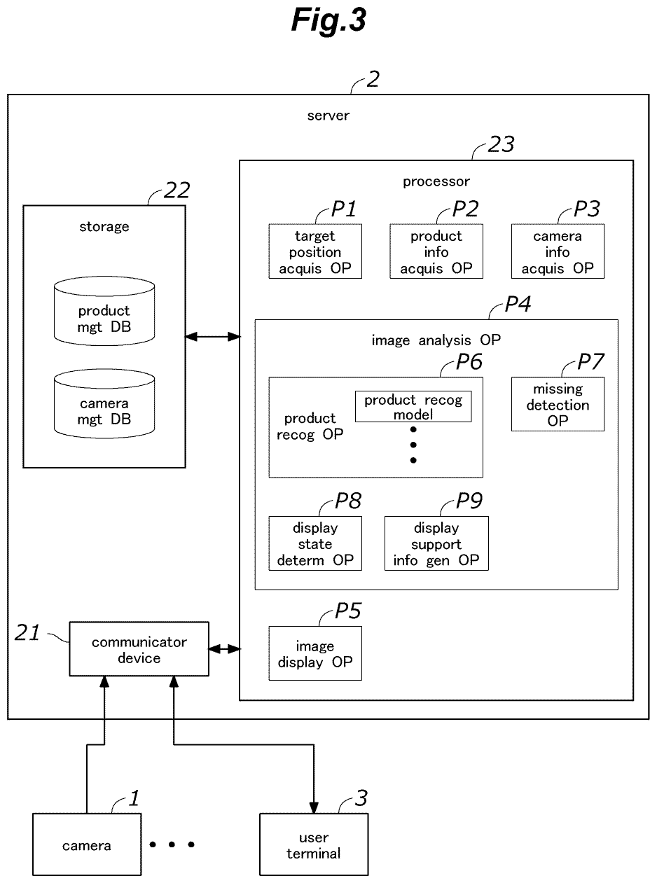

Next, a schematic configuration of the server 2 of the first embodiment will be described. FIG. 3 is a block diagram showing a schematic configuration of the server 2.

The server 2 includes a communication device 21, a storage 22, and a processor 23.

The communication device 21 communicates with the camera 1 and the user terminal 3.

The storage 22 stores programs that are executable by the processor 23. The storage 22 also stores registered information records of a product management database and a camera management database.

The product management database contains information on display states of products in the store, specifically information on product display plans including display locations (such as shelves, and shelf tiers) of the products, and recommended display states thereof.

The camera management database contains information on the installation state of each of the cameras 1 in the store, which, in particular, includes installation position information on the camera's installation position, imaging-angle information on the imaging angle, and relative-position information on the relative position with regard to the store shelf that is to be imaged by that camera (display area), such as information on the blind spots (areas that are not visible due to shielding) of the camera 1. In the case where a PTC camera is used as the camera 1, the camera management database may contain control information on the operation control of the camera 1, thereby enabling the PTC camera to image a plurality of store shelves with the imaging position that is regularly changed.

The processor 23 performs various processing operations by executing programs stored in the storage 22. In the present embodiment, the processor 23 performs a target position acquisition operation P1, a product information acquisition operation P2, a camera information acquisition operation P3, an image analysis operation P4, and a screen display operation P5.

In the target position acquisition operation P1, the processor 23 acquires the position of a target store shelf (display area) based on the user's current position. Specifically, the processor 23 receives position information i.e., information on the position which is determined by indoor positioning, from the user terminal 3 and acquires the position of the target store shelf based on the position information on the position of the user terminal 3. In some cases, the target store shelf may be designated by the user. Specifically, the user performs an operation on the user terminal to designate the target store shelf, and, based on instruction information received from the user terminal 3, the processor 23 acquires the position of the target store shelf.

In the product information acquisition operation P2, the processor 23 acquires product information i.e., information on products displayed on the target store shelf from the product management database. The product information includes information on the display state of each product in the store; that is, information on the product display plan including the display position of each product (store shelf, shelf tiers, etc.), and information on the recommended display state thereof.

In the camera information acquisition operation P3, the processor 23 acquires camera information, i.e., information on the camera 1, which is used to image the target store shelf, from the camera management database. The camera information includes details about the installation state of each camera 1 within the store, i.e., information on the installation position and imaging direction (imaging angle) of each camera 1, information on the store shelf (display area) imaged by the camera 1, and information on the relative positional relationship between the camera 1 and the target display area, such as information on the blind spots (areas that are not visible due to shielding) of the camera 1.

The image analysis operation P4 includes a product recognition operation P6, a missing detection operation P7, a display state determination operation P8, and a display support information generation operation P9.

In the product recognition operation P6 (object recognition operation), the processor 23 recognizes products displayed on store shelves based on images of the store shelves. The product recognition operation P6 uses a plurality of product recognition models (identifiers) to identify each product. A product recognition model is a machine-learning-based model constructed using machine learning technology such as deep learning. The product recognition model outputs a product recognition score that indicates the degree of certainty (degree of confidence) that the product is a certain product.

In the missing detection operation P7, the processor 23 detects the missing state of the target store shelf, i.e., the state in which products to be displayed on the store shelf are missing (at a predetermined missing products ratio), based on the recognition results of the product recognition operation P6.

In the display state determination operation P8, the processor 23 determines whether or not the display state of the product displayed on the target store shelf is an appropriate state based on the recognition results of the product recognition operation P6. Specifically, the processor 23 determines whether or not the display state of the product is the appropriate state based on the product recognition score output from the product recognition model in the product recognition operation P6. When the product recognition score is equal to or greater than a predetermined reference value, the processor 23 determines that the display state is the appropriate state, and when the product recognition score is lower than the predetermined reference value, the processor 23 determines that the display state is an inappropriate state. This enables the detection of products in the inappropriate display state.

In the product recognition operation P6, the plurality of product recognition models are used for corresponding products. In particular, in the case of a product recognition model associated with the recommended display state of a corresponding product, when the input image shows the product in a state close to the recommended display state, the product recognition score output becomes high. Therefore, the product recognition score output from the product recognition model represents a score indicating the ease of recognition and also a score indicating the level of appropriateness of the display state. As a result, the product recognition score enables accurate determination of the appropriateness of the display state.

In the display support information generation operation P9, the processor 23 generates display support information that assists the user's display work. Specifically, the processor 23 generates information on the position of a store shelf where the missing state occurs, information on the position of a product in the inappropriate display state, and information on the recommended display state for a target product.

In the screen display operation P5, the processor 23 displays a screen showing display support information on the user terminal 3. Specifically, the processor 23 displays a screen on the user terminal 3 that provides a notification of detection of the missing state (missing alert), presents a recommended display state for the detected product in the missing state, provides a notification of detection of the inappropriate display state (inappropriate display alert), and presents a recommended display state for the detected product in the inappropriate display state.

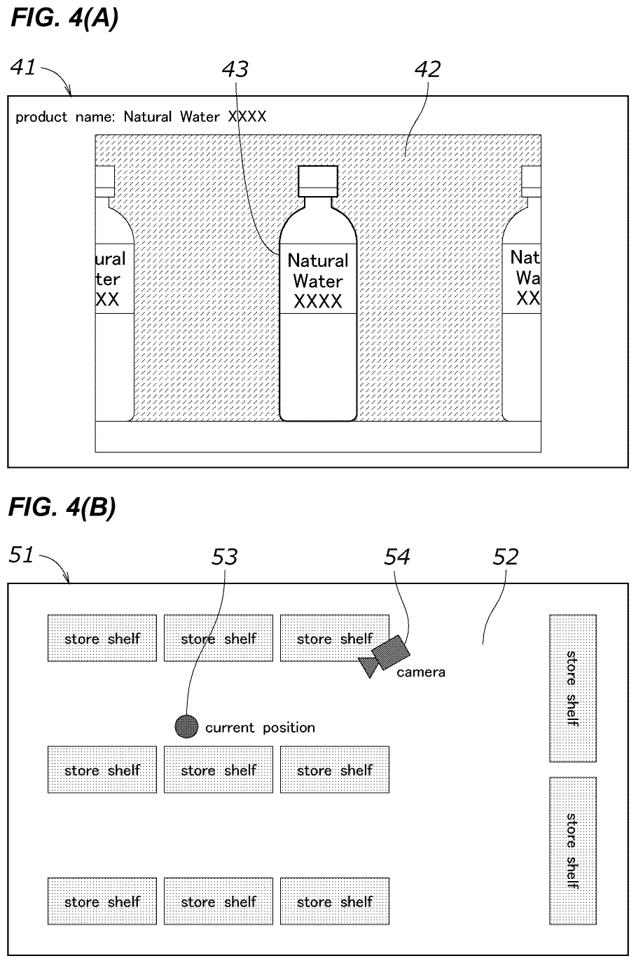

Next, a screen displayed on the user terminal 3 when the display state of a product is a missing state will be described. FIG. 4 is an explanatory diagram showing the screen displayed on the user terminal 3 when the display state of a product is a missing state. In particular, the screen of FIG. 4 is displayed in a recommended display presentation mode and presents the recommended display state to the user.

When the server 2 detects the missing state on a store shelf, the user terminal 3 notifies the user of the missing state on the store shelf and displays a store shelf screen 41 shown in FIG. 4(A) as a screen that presents the recommended display state to the user in the case of the missing state, and also displays a store map screen 51 shown in FIG. 4(B).

The store shelf screen 41 shown in FIG. 4(A) presents the recommended display state of products on a target store shelf to the user. Specifically, in the store shelf screen 41, a product image 43 representing the recommended display state of the product is overlaid on a captured image 42 of the target store shelf. FIG. 4(A) shows the missing state of a product, where the product image 43 is overlaid at the position of the missing product in the captured image 42. The product image 43 may be an actual image of the product or may be an image created by using CG technology.

The store map screen 51 shown in FIG. 4(B) displays a store map 52 showing the layout of store shelves (display areas) within the store. The store map screen 51 displays a current position mark 53 and a camera mark 54 on the store map 52. The current position mark 53 indicates the user's current position. The current position mark 53 is displayed based on position information acquired by indoor positioning performed by the user terminal 3. The camera mark 54 indicates the installation position of the camera 1. The store map screen 51 allows the user to determine the user's current position and the position of the camera 1 that is capturing the store shelf in front of the user.

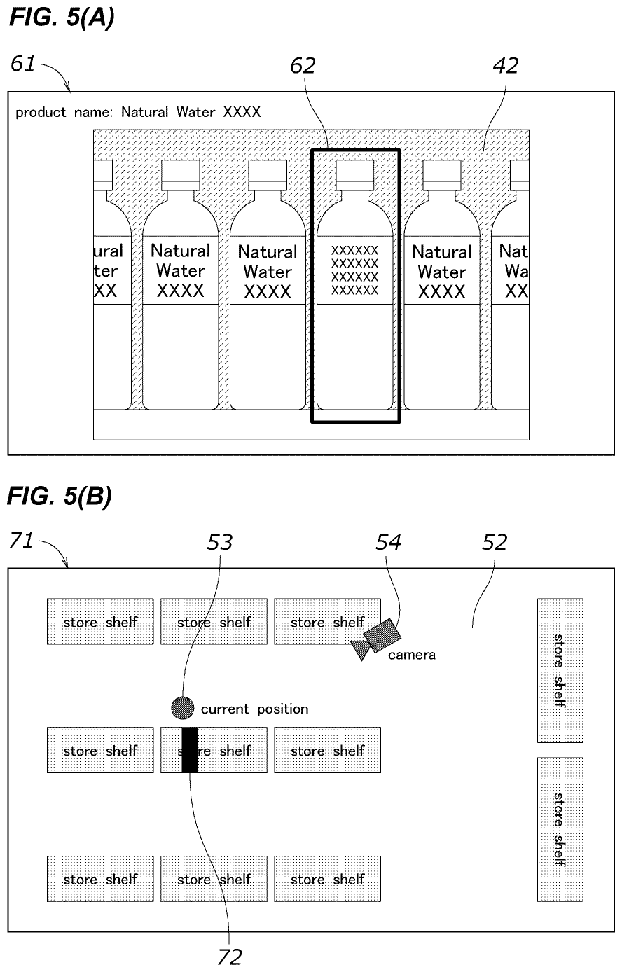

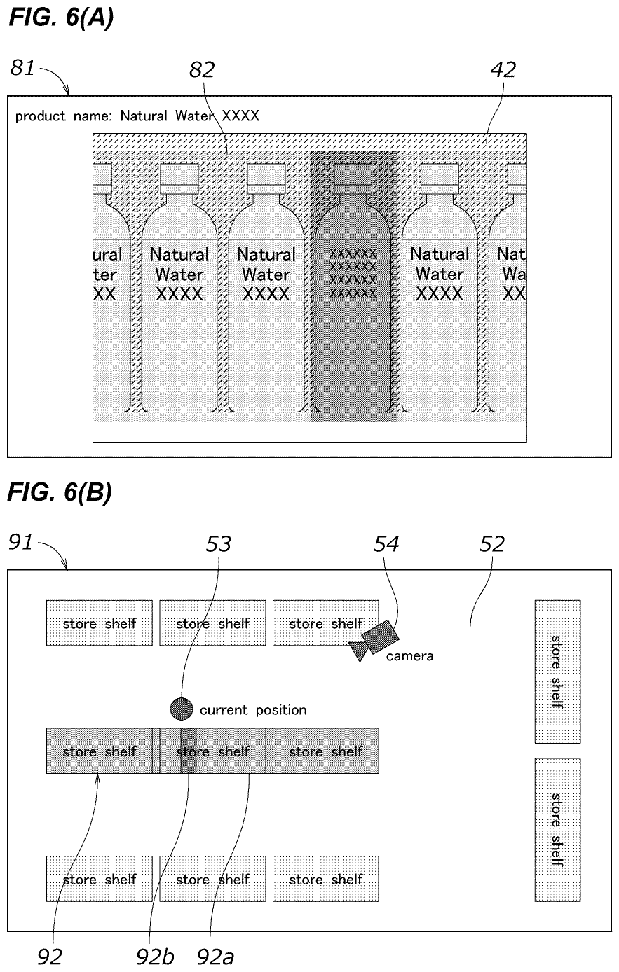

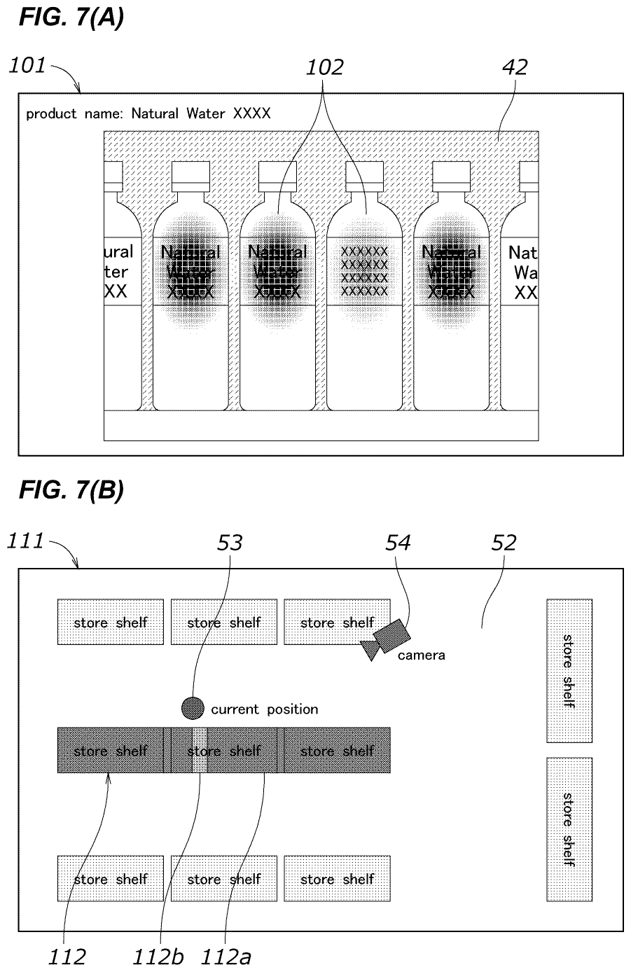

Next, screens displayed on the user terminal 3 when the display state of a product is the inappropriate display state will be described. FIGS. 5 to 7 are explanatory diagrams that notify the user of the inappropriate display states. FIG. 5 shows a screen displayed when in a first inappropriate display state notification mode, FIG. 6 shows a screen displayed when in a second inappropriate display state notification mode, and FIG. 7 shows a screen displayed when in a third inappropriate display state notification mode. The first, second, and third inappropriate display notification modes can be pre-selected by a user or administrator, and can be switched as appropriate.

When the server 2 detects an inappropriate display state of a product, the user terminal 3 displays a screen that notifies the user of the inappropriate display state of the product. In the first inappropriate display notification mode, the user terminal 3 displays a store shelf screen 61 and a store map screen 71 shown in FIGS. 5(A) and 5(B), respectively.

The store shelf screen 61 shown in FIG. 5(A) presents products in an inappropriate display state on the target store shelf to the user. Specifically, a rectangular frame image 62 surrounding a product in an inappropriate display state among the products displayed on the target store shelf is overlaid onto the captured image 42 of the target store shelf.

The server 2 uses a product recognition model to recognize products from images of store shelves. The product recognition model outputs a product recognition score that indicates the degree of certainty (degree of confidence) that the product is a certain product. In the example shown in FIG. 5(A), the target product is a plastic bottle of drinking water. In this case, the front side of the label printed with the product name (Natural Water XXXX) includes many features that can be used to identify the product, which makes the product recognition score output from the product recognition model high. The back side of the label, on which ingredients are printed, includes fewer features for identification of the product, which makes the product recognition score output from the product recognition model lower. The server 2 determines that the display state is an appropriate state when the product recognition score is equal to or greater than a predetermined reference value, and determines that the display state is an inappropriate state when the product recognition score is below a predetermined reference value.

As shown in FIG. 5(A), when the target product is a plastic bottle of drinking water, an inappropriate display state may occur when the front and back (top and bottom) of the label are reversed. However, an inappropriate display state occurs not only when the front and back are reversed. For example, in the case of boxed products, the top and bottom or the vertical and horizontal orientations may be reversed. In addition to cases where the front and back (top and bottom) of the product are completely reversed, when the orientation of the product significantly differs from the recommended display state, the server 2 can determine that a display state is an inappropriate display state.

In the store map screen 71 shown in FIG. 5(B), an image region 72 of a product in the inappropriate display state is highlighted in the store map 52. Specifically, the image region 72 of the product in the inappropriate display state is shown in a different color (e.g., red) from the other region of the image of the store shelf. The highlighting of the image region 72 may also be achieved by various display elements, such as patterns, that are different from those of the other region of the store shelf image.

In the second inappropriate display notification mode, the user terminal 3 displays a store shelf screen 81 and a store map screen 91 shown in FIGS. 6(A) and 6(B), respectively.

The store shelf screen 81 shown in FIG. 6(A) presents products in an inappropriate display state on the target store shelf to the user, in a similar manner to the first inappropriate display notification mode (FIG. 5(A)). In this mode, a heat map image 82 that visualizes the level of appropriateness of the display state is overlaid in a semi-transparent manner onto the captured image 42 of the target store shelf.

In the heat map image 82, the display states of products are visualized in different colors according to whether the display state is appropriate or not. Specifically, in the heat map image 82, image regions of products which are determined to be in the appropriate state are shown in a certain color, e.g., in red, for example, and image regions of products which are determined to be inappropriate are shown in a different color, e.g., in blue. In the particular example shown in FIG. 6(A), in the heat map image 82, a rectangular area that covers an entirety of a product is shown in a color that is determined based on the appropriateness of the display state of the product.

In the store map screen 91 shown in FIG. 6(B), a heat map image 92 is displayed over a store shelf on which products are in an inappropriate display state in the store map 52. In the heat map image 92, the image regions 92a of products which are determined to be in the appropriate display state are shown in a certain color, e.g., in red, and the image regions 92b of products which are determined to be in the inappropriate display state are shown in a different color e.g., in blue, in a similar manner to the store shelf screen 81 shown in FIG. 6(A).

In the examples shown in FIGS. 6(A) and (B), image regions in the heat map images 82 and 92 are shown in two different colors depending on whether the display state is appropriate or not. However, image regions in the heat map images 82 and 92 may be shown in three or more different colors depending on the level of appropriateness of the display state.

In the third inappropriate display notification mode, the user terminal 3 displays a store shelf screen 101 and a store map screen 111 shown in FIGS. 7(A) and 7(B), respectively.

Similarly to the second inappropriate display notification mode, the store shelf screen 101 shown in FIG. 7(A) shows a heat map image 102 that visualizes the level of appropriateness of the display state is overlaid in a semi-transparent manner onto the captured image 42 of the target store shelf. In this mode, the heat map image 102 visualizes, by using a product recognition model (machine learning model), recognition states of products in the product recognition operation (image recognition operation), i.e., a basis for determination to generate recognition results.

The heat map image 102 is a gradation image that represents the impacts of parts (e.g., pixel units or blocks containing multiple pixels) within the captured image on the recognition result of the product recognition operation. More specifically, the heat map image 102 is an image of gradation of hue, in which the hue gradually changes according to the impact on the recognition result. The heat map image 102 may be an image of gradation of color density, in which the color density (brightness) gradually changes according to the impact on the recognition result.

In the heat map image 102, the display states of products are visualized in different colors according to whether or not the product recognition score is equal to or greater than a predetermined reference value, i.e., whether the display state is appropriate or not. Specifically, in the heat map image 102, display states are shown in different color families depending on whether the display state is appropriate or not. For example, products for which the product recognition score is equal to or greater than the predetermined reference value and the display state is appropriate, the heat map image 102 is shown in warm colors. In this case, the hue changes from red to yellow in order from high to low impact, for example. Products for which the product recognition score is below the predetermined reference value and the display state is inappropriate, the heat map image 102 is shown in cool colors. In this case, for example, the hue changes from green to blue in order from high to low impact, for example.

In the example shown in FIG. 7, the target product is a plastic bottle of drinking water. In this case, as the label printed with the product name in the captured image has a high impact on the recognition result, the heat map image 102 appears in the label area.

This allows a user to easily identify a product that is in an inappropriate display state. In particular, this allows the user to easily recognize that the inappropriate display state is determined based on a label, i.e., that the part of the product which the user should pay attention to when performing display work is a label.

In the store map screen 111 shown in FIG. 7(B), a heat map image 112 is displayed in a similar manner to the store map screen 91 shown in FIG. 6(B) displayed in the second inappropriate display notification mode. However, in this heat map image 112, the basis for determination of recognition results is visualized. In the example shown in FIG. 7(B), the parts 112a of the products with high impacts on the recognition result are shown in a dark color, and the parts 112b of the products with low impacts on the recognition result are shown in a light color.

FIG. 4(A) shows an example in which a product is missing. However, in the case that a product is in an inappropriate display state, the recommended display state of the product is presented to the user in a similar manner. That is, after the inappropriate display state of the product is notified to the user via the screens shown in FIGS. 5, 6, and 7, the product image 43 representing the recommended display state of the product is overlaid onto the captured image 42 of the target store shelf. In this case, the product image 43 representing the recommended display state of the product is overlaid on or near the image of the product that is in the inappropriate display state, in the captured image 42.

In the present embodiment, presented to a user as a recommended display state is a display state which enables easy product recognition using a product recognition model in the operation of product recognition (object recognition), i.e., a display state in which the product recognition score output from the product recognition model is high. However, in other embodiments, a recommended display state presented to a user may be determined based on criteria other than the ease of product recognition.

For example, when the pattern of an object that forms the background of a product (such as the back panel of a shelf or a wall) resembles that of the product, the difference between the object forming the background of the product and the product itself, which is detected in the product recognition operation, is small, which can cause errors in detection of missing or determination of display state. Also, a change in the position or orientation of a product may increase the difference between the object that forms the background of the product and the product itself, which can reduce errors in detection of missing or determination of display state. Thus, a display state in which a small difference occurs between a product and a background object during the product recognition operation, may be notified to a user as an inappropriate display state. A display state in which a large difference occurs between a product and a background object may be presented to a user as a recommended display state for the product.

In addition, when display areas for different products are adjacent to each other in a product display plan (planogram) and a product is arranged across the boundary between the display areas, errors can occur in detection of missing or determination of display state. Thus, upon detection of a product that is displayed across the boundary between different display areas, an inappropriate display state may be notified to a user. Also, a display state in which products are arranged without crossing the boundary between different display areas may be presented to a user as a recommended display state for the products. The feature can also be adopted for products of the same type which are displayed in separate display areas.

Furthermore, the display state appropriate for a product varies depending on the shape and stability of the product. For example, boxed products can be stacked, but bagged products may not be stackable. Thus, a recommended display state for products that are determined to be stackable based on information about the shape and stability of the product and presented to a user may be a stacked display state.

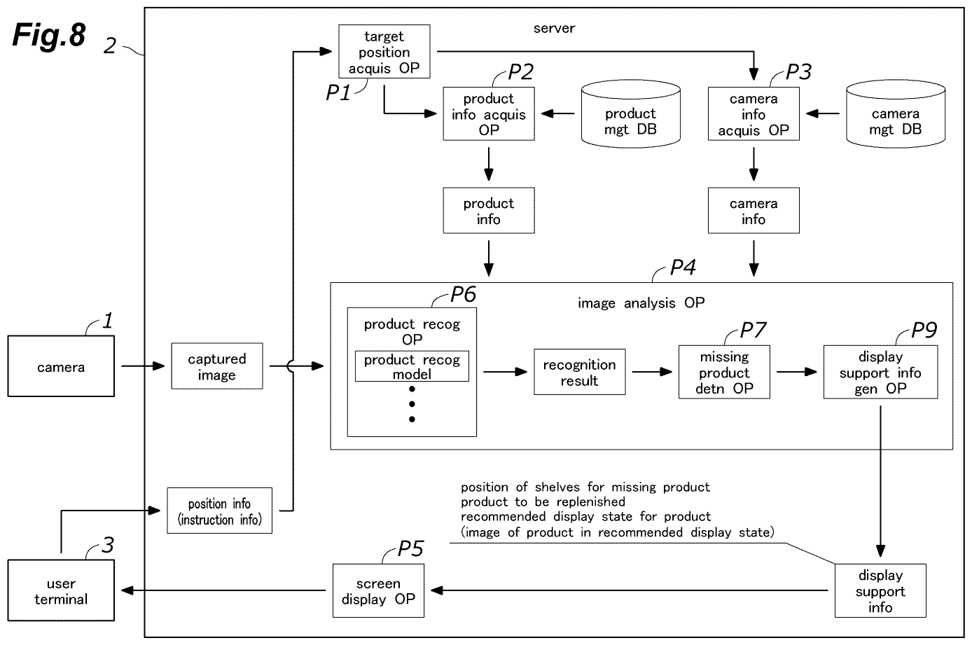

Next, operations performed by the server 2 when the display state of a product is a missing state will be described. FIG. 8 is a block diagram showing an overview of operations performed by the server 2 when the display state of a product is the missing state.

The server 2 receives position information, i.e., information on the position determined by indoor positioning, from the user terminal 3, and, based on the position information from the user terminal 3, acquires the position of the target store shelf (display area) (target position acquisition operation P1). In other cases, the server 2 may acquire the position of the target store shelf based on instruction information which a user has entered by operating on the user terminal 3, the instruction information designating a target store shelf.

Next, the server 2 acquires product information, i.e., information about the products to be displayed on the target store shelf, from the product management database (product information acquisition operation P2). The product information includes information on the display state of each of the products in the store, specifically, information, for each product, on a product display plan, including a display position (such as store shelf or shelf level), and a recommended display state.

The server 2 acquires camera information, i.e., information about the cameras 1 that can image the target store shelf, from the camera management database (camera information acquisition operation P3). The camera information includes information on the installation state of each of the cameras 1 within the store, specifically, information, for each camera 1, on an installation position, an imaging angle, store shelves (display areas) that are imaged by the camera 1, and relative positions of the camera 1 to the display areas to be imaged, such as the camera 1's blind spots (areas that are not visible due to shielding).

The server 2 receives a captured image from the camera 1 that images the target store shelf, and based on the image of the store shelf, recognizes products displayed on the store shelf (product recognition operation P6).

Next, the server 2 detects the missing state of the target store shelf based on the recognition result acquired in the product recognition operation P6 (missing detection operation P7).

Next, the server 2 generates display support information that supports the user's display work (display support information generation operation P9). Specifically, the server 2 generates, as the display support information, information on the position of the store shelf where the missing state occurs, the type of product that needs to be replenished, and the recommended display state of the product (specifically, an image of the product in the recommended display state).

Next, the server 2 displays a screen showing the display support information generated in the display support information generation operation P9 on the user terminal 3 (screen display operation P5). Specifically, the server 2 transmits to the user terminal 3 the display information that prompts the user to display products on the store shelf where the missing state occurs, and further display information including an image of a product(s) in the recommended display state that is overlaid onto the image of the store shelf.

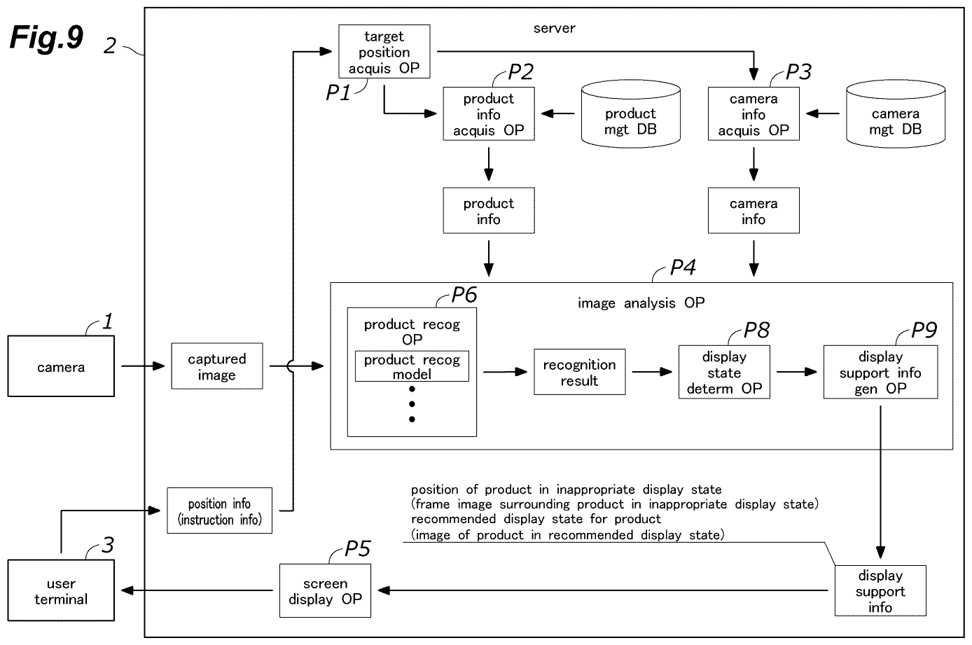

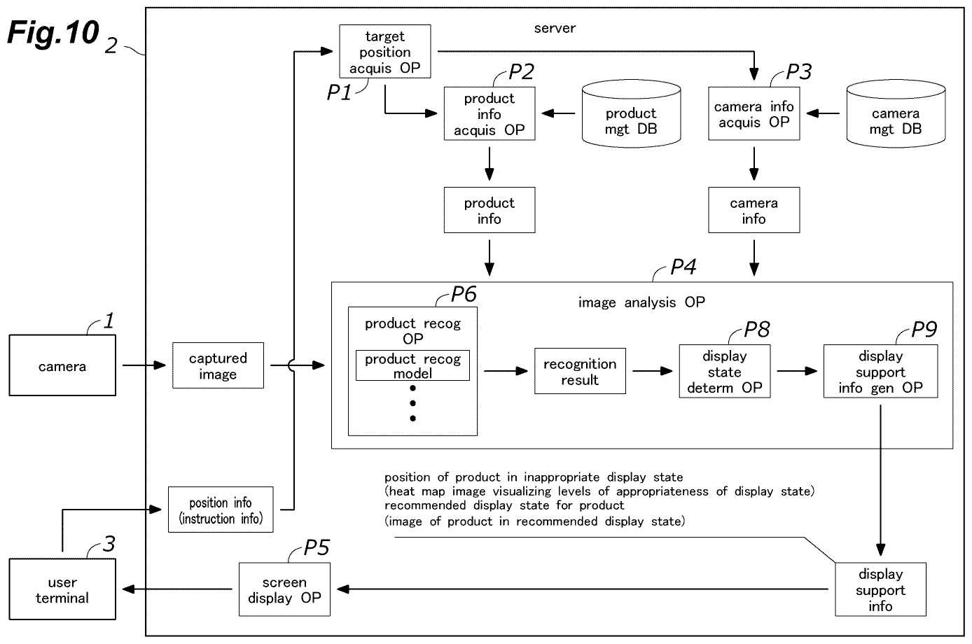

Next, operations performed by the server 2 when the display state of a product is the inappropriate display state will be described. FIGS. 9 and 10 are block diagrams showing an overview of operations performed by the server 2 when the display state of a product is the inappropriate display state. FIG. 9 shows an overview of operations performed by the server 2 in a first inappropriate display notification mode, while FIG. 10 shows an overview of operations performed by the server 2 in a second inappropriate display notification mode. Operations performed by the server 2 in a third inappropriate display notification mode are same as those for the second inappropriate display notification mode shown in FIG. 10.

As shown in FIGS. 9 and 10, in the case of the inappropriate display state, the server 2 performs the target position acquisition operation P1, product information acquisition operation P2, camera information acquisition operation P3, and product recognition operation P6 in a similar manner to the case of the missing state (FIG. 8).

Next, the server 2 determines whether the display state of product(s) displayed on the target store shelf is the inappropriate display state based on the recognition result acquired in the product recognition operation (display state determination operation P8). In this operation, the server 2 extracts, as products in the inappropriate display state, products with product recognition scores acquired in the product recognition operation are less than the predetermined reference value.

Next, the server 2 generates display support information that assists the user's display work (display support information generation operation P9). In this operation, the server 2 generates information on the position of a product in the inappropriate display state as display support information. Specifically, in the first inappropriate display notification mode shown in FIG. 9, the server 2 generates information on a frame image surrounding the product in the inappropriate display state. In the second inappropriate display notification mode shown in FIG. 10, the server 2 generates information on a heat map image that visualizes the level of appropriateness of the display state. In addition, in the first and second inappropriate display notification modes, the server 2 generates information on the recommended display state of a product, specifically, images (product images) representing the product in the recommended display state.

Next, the server 2 displays a screen that presents the display support information generated in the display support information generation operation P9 to the user terminal 3 (screen display operation P5). In this operation, in the first inappropriate display notification mode shown in FIG. 9, the server 2 displays the store shelf screen 61 (FIG. 5(A)) and the store map screen 71 (FIG. 5(B)) on the user terminal 3. In the second improper display notification mode shown in FIG. 10, the server 2 displays the store shelf screen 81 (FIG. 6(A)) and the store map screen 91 (FIG. 6(B)) on the user terminal 3. In the third improper display notification mode (not shown), the server 2 displays the store shelf screen 101 (FIG. 7(A)) and the store map screen 111 (FIG. 7(B)) on the user terminal 3.

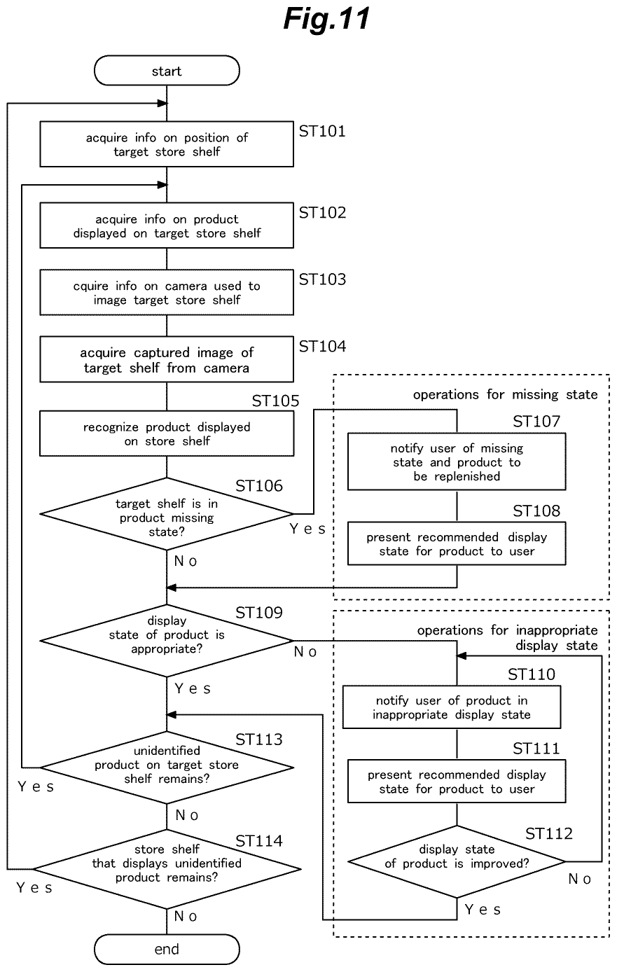

Next, a procedure of operations performed by the server 2 will be described. FIG. 11 is a flow chart showing the procedure of operations performed by the server 2.

In the server 2, the processor 23 first receives from the user terminal 3 position information obtained by indoor positioning at the user terminal 3, and then acquires the position of the target store shelf (display area) based on the position information from the user terminal 3 (target position acquisition process) (ST101).

Next, the processor 23 acquires information about products displayed on the target store shelf, such as information on the recommended display state (product information acquisition process) (ST102). Furthermore, the processor 23 acquires information about the camera 1 that images the target store shelf (camera information acquisition process) (ST103).

Next, the processor 23 acquires a captured image of the target store shelf from the camera 1 that images the target store shelf (ST104).

Next, the processor 23 recognizes the products displayed on the target store shelf based on the captured image from the camera 1 (product recognition operation) (ST105). Next, based on the recognition results acquired in the product recognition operation, the processor 23 determines whether the target store shelf is in the missing state, i.e., whether a product to be displayed on the store shelf is missing (missing detection operation) (ST106).

When the target store shelf is not in the missing state (No in ST106), the processor 23 then determines whether the display state of the product displayed on the target store shelf is in the appropriate display state (display state determination process) (ST109).

When the product is in the appropriate display state (Yes in ST109), the processor 23 then determines whether there is any undetermined product that remains on the target store shelf (ST113).

When there is no undetermined product (product for which determination has not been made) that remains on the target store shelf (No in ST113), the processor 23 then determines whether there is any store shelf that remains for which determination has not been completed (ST114).

When there is no undetermined shelf (shelf for which determination has not been completed) (No in ST114), the process ends.

When there is an undetermined product that remains on the target store shelf (No in ST113), the process returns to ST102 and starts operations for the next target product. When there is an undetermined shelf (Yes in ST114), the process returns to ST101 and starts operation for the next target store shelf.

When the target store shelf is in the missing state (Yes in ST106), the processor 23 then notifies the user that the target store shelf is in the missing state and that the product needs to be replenished (missing alert) (ST107). Next, the processor 23 presents the recommended display state of the product to the user (ST108), and the process proceeds to ST109. In this step, the processor 23 displays the store shelf screen 41 (FIG. 4(A)) and the store map screen 51 (refer to FIG. 4(B)) on the user terminal 3. This allows the user to perform the work of replenishing products on the store shelf in the missing state. In some cases, the processor 23 may simultaneously perform the notification of the missing state (ST107) and the display of the recommended display state (ST108) on the same screen.

When the product is in the inappropriate display state (No in ST109), the processor 23 then notifies the user of the product in the inappropriate display state in the target store shelf (inappropriate display alert) (ST110). In this step, the processor 23 displays the store shelf screen 61, 81, 101 (FIGS. 5(A), 6(A), and 7(A)) and the store map screen 71, 91, 111 (FIGS. 5(B), 6(B), and 7(B)) on the user terminal 3. Next, the processor 23 presents the recommended display state of the product to the user (ST111). This allows the user to perform display work of rearrangement of products that are in the inappropriate display state. In some cases, the processor 23 may simultaneously perform the notification of the inappropriate display state (ST110) and the presentation of the recommended display state (ST111) on the same screen.

Next, the processor 23 determines whether the display state of the product has improved (ST112). When the display state of the product has improved (Yes in ST112), the process proceeds to ST113. When the display state of the product has not improved (No in ST112), the process returns to ST110, and the operations from ST110 to ST112 are repeated until the display state of the product is improved.

### Variant of First Embodiment

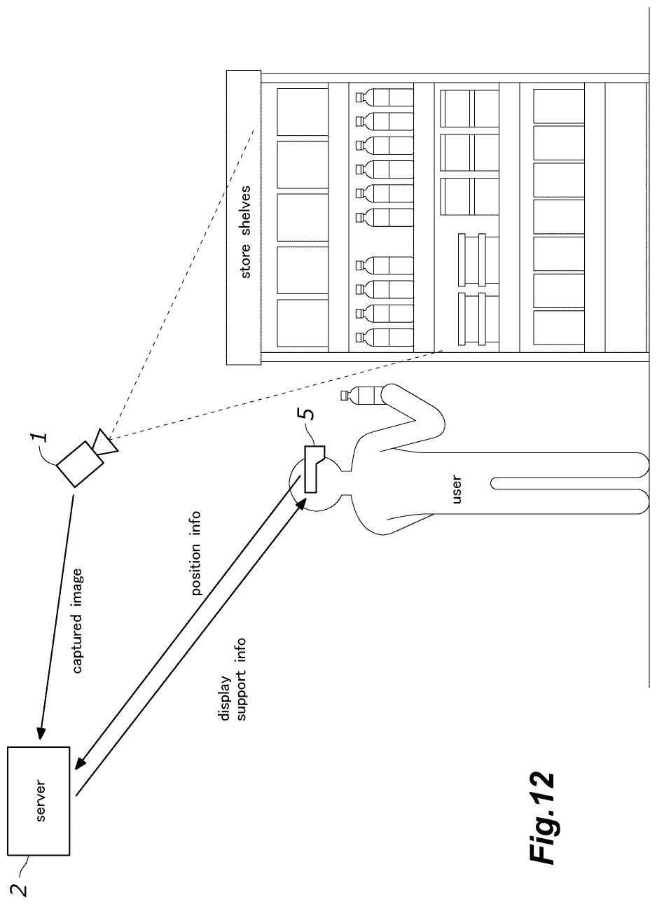

Next, a variant of the first embodiment of the present disclosure will be described. Except for what will be discussed here, this embodiment is the same as the above-described first embodiment. FIG. 12 is a diagram showing an overview of a sales floor management system according to a variant of the first embodiment.

In the first embodiment (FIG. 2), the user terminal 3 (such as a tablet device) carried by a user presents display support information to the user. In the variant of the first embodiment, a wearable device 5 worn by the user presents the display support information to the user. The wearable device 5 is connected to the server 2 via a network.

The wearable device 5 displays a virtual object overlaid on a real space within the user's field of view, thereby implementing AR (augmented reality) or MR (mixed reality).

In the recommended display presentation mode, the wearable device 5 displays the recommended display state of a product as display support information. Specifically, in the recommended display presentation mode shown in FIG. 4(A), the wearable device 5 displays, as a virtual object, a product image that is the same as a product image 43 displayed on the store shelf screen 41 and is overlaid on the real space. This feature supports the user's display work of replenishing products on store shelves in the missing state. This also supports the user's display work of re-arranging products that are in the inappropriate display state.

In the inappropriate display notification mode, the wearable device 5 displays a product in the inappropriate display state to the user as display support information. Specifically, in the first inappropriate display notification mode shown in FIG. 5(A), the wearable device 5 displays, as a virtual object, a frame image that is the same as a frame image 62 displayed on the store shelf screen 61 and is overlaid on the real space. In the second inappropriate display notification mode shown in FIG. 6(A) and the third inappropriate display notification mode shown in FIG. 7(A), the wearable device 5 displays, as a virtual object, a heat map image that is the same as the heat map images 82 and 102 displayed on the store shelf screens 81 and 101 and is overlaid on the real space. This feature allows the user to easily identify products in the inappropriate display state.

Examples of wearable devices 5 that can implement AR and MR include devices in which a virtual object is displayed on a transparent display or retinal projection display, and devices in which a virtual object overlaid on an image of a real space image captured by a camera is displayed on a non-transparent display.

### Second Embodiment

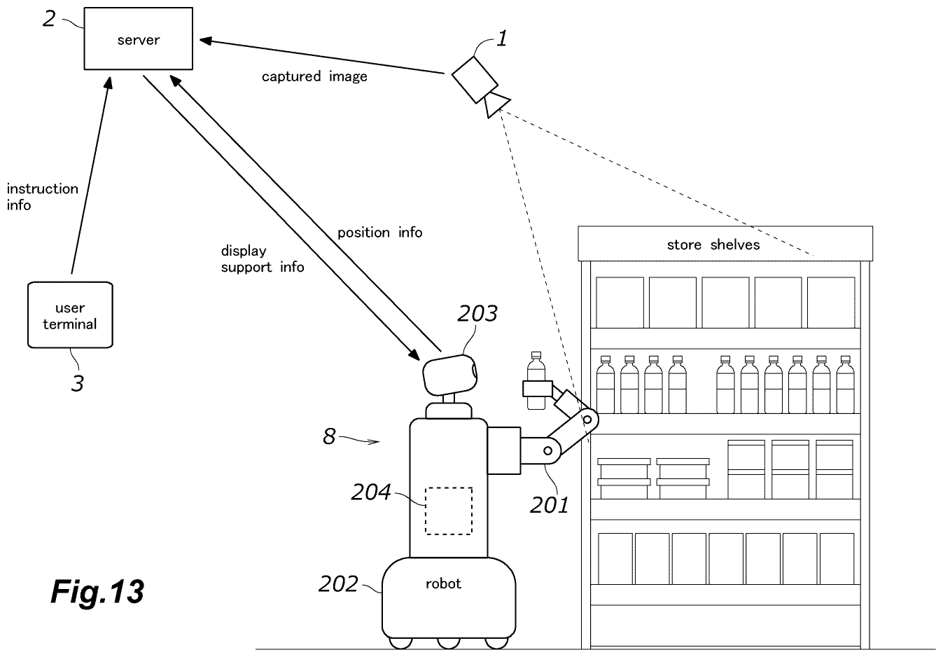

Next, a second embodiment of the present disclosure will be described. Except for what will be discussed here, this embodiment is the same as the above-described first embodiment. FIG. 13 is a diagram showing an overview of a sales floor management system according to the second embodiment.

The system includes a camera 1, a server 2, a user terminal 3, and a robot 8. In the first embodiment (FIG. 2), the user performs the product display work, while, in the present embodiment, the robot 8 performs the product display work. The robot 8 is connected to the server 2 via a network.

The robot 8 includes an arm 201 (manipulator), a traveling unit 202, a camera 203, and a controller 204. The arm 201 is capable of holding products and can display the products on or remove them from store shelves. The traveling unit 202 is configured to enable autonomous driving within the store. The camera 1 captures images of the robot's surroundings. The controller 204 includes a processor and a memory, and performs operations for recognizing products displayed on store shelves based on images captured by the camera 1, operations for handling products by the arm 201, and operations for autonomous navigation by the traveling unit 202.

The robot 8 performs display work based on instructions from the server 2. Specifically, when the missing state is detected in a store shelf, the robot 8 retrieves a missing product from a backyard, transport it to the front of the store shelf where the missing state was detected, and replenishes the product. When an inappropriate display state is detected, the robot 8 moves to the front of the store shelf where the inappropriate display state was detected and rearranges the products.

In the example shown in FIG. 13, the robot 8 performs display work from the sales floor side. However, the robot 8 can also perform display work from the backyard side. In the latter case, the recommended display state is the reverse of that for display work performed from the sales floor side.

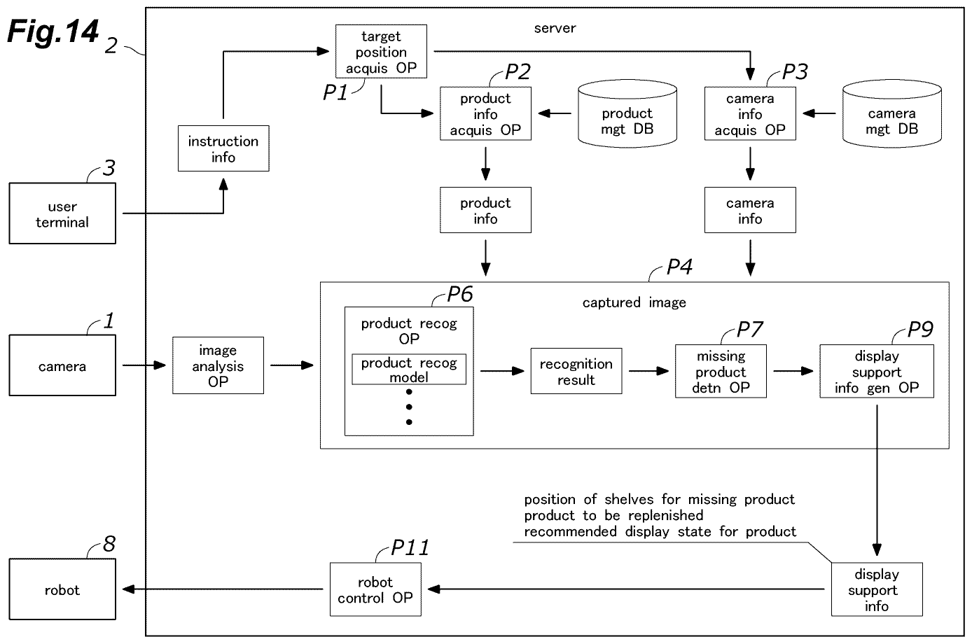

Next, operations performed by the server 2 and the robot 8 of the second embodiment will be described. FIG. 14 is a block diagram showing an overview of operations performed by the server 2 when the display state of a product is the missing state.

The server 2 acquires the position of the target store shelf based on instruction information which a user has entered by operating on the user terminal 3, the instruction information designating a target store shelf (target position acquisition operation P1).

In other cases, the robot 8 may move around the store and perform necessary display work. In this case, the server 2 receives position information from the robot 8, i.e., information on the position determined by indoor positioning, and, based on the position information from the robot 8, acquires the position of the target store shelf.

Next, the server 2 performs the product information acquisition operation P2, camera information acquisition operation P3, product recognition operation P6, and missing detection operation P7 in a similar manner to the first embodiment (FIG. 8).

Next, the server 2 generates, as the display support information, information on the position of the store shelf where the missing state occurs, the type of product that needs to be replenished, and the recommended display state of the product (display support information generation operation P9). Next, the server 2 transmits to the robot 8 operation instruction information including the display support information, i.e., information that instructs the robot 8 to display products on the store shelf where the missing state occurs into the recommended display state (robot control operation P11).

The robot 8 performs display work based on the display support information received from the server 2. Specifically, the robot 8 transports a product to be replenished to the position of the store shelf where the missing state occurs, and displays the product on the store shelf in the recommended display state. The robot 8 is capable of autonomous navigation based on the position information including its position determined by indoor positioning. However, the server 2 may also control the movement of the robot 8 based on the position information received from the robot 8.

FIG. 14 shows an example in which a product is missing. However, in the case that a product is in an inappropriate display state, the server 2 may perform such operations that the screen display operation P5 performed by the server 2 in the first embodiment (FIGS. 8, 9 and 10) is replaced with the robot control operation P11.

The operations performed by the server 2 are generally the same as those of the first embodiment (FIG. 11), except that the notification of a missing state (ST107), the presentation of a recommended display state for the missing state (ST108), the notification of an inappropriate display state (ST110), and the presentation of a recommended display state (ST111) are made to the robot 8 in place of a user.

While specific embodiments of the present disclosure are described herein for illustrative purposes, the present disclosure is not limited to those specific embodiments. Various changes, substitutions, additions, and omissions may be made to elements and features of the embodiments without departing from the scope of the invention. Moreover, elements and features of the different embodiments may be combined with each other to yield another embodiment of the present disclosure.

### INDUSTRIAL APPLICABILITY

A sales floor management system and a sales floor management method of the present disclosure, have an effect of enabling achievement of a display state of products in a sales floor of a store that can provide a good appearance of the products to customers and ensure high recognition accuracy of a product recognition model, and are useful as a sales floor management system and a sales floor management method for managing a display state of products on a sales floor of a store based on a captured image acquired from a camera for imaging the sales floor.

### GLOSSARY

1 camera
2 server (information processing device, sales floor management device)
3 user terminal (display device)
5 wearable device
8 robot
22 storage
23 processor
41, 61, 81, 101 store shelf screen
42 captured image
43 product image
51, 71, 91, 111 store map screen
52 store map
53 current position mark
54 camera mark
62 frame image
82, 92, 102 heat map image

1. A sales floor management system for managing a display state of products on a sales floor of a store based on a captured image acquired from a camera for imaging the sales floor, comprising:
an information processing device that performs operations including:
using a product recognition model to recognize products from the captured image;
based on the recognition result, generating display support information for supporting display work performed by a user; and
presenting the display support information to the user,
wherein the operations performed by the information processing device include generating, as the display support information, information on a recommended display state of target products.

2. The sales floor management system as claimed in claim 1, wherein the operations performed by the information processing device include:
when detecting a missing state based on the captured image, generating, as the display support information, information that notifies the user of a position of a display area that is in the missing state, and presenting the recommended display state of products to the user.

3. The sales floor management system as claimed in claim 1, wherein the recommended display state is a display state in which a product recognition score output from the product recognition model is equal to or greater than a predetermine reference value.

4. (canceled)

5. The sales floor management system as claimed in claim 1, wherein the operations performed by the information processing device include:
when detecting an inappropriate display state of a product, generating, as the display support information, information that notifies the user of a position of the product that is in the inappropriate display state, and presenting the recommended display state of products to the user.

6. The sales floor management system as claimed in claim 5, wherein the operations performed by the information processing device include
detecting the inappropriate display state of the product based on a product recognition score output from the product recognition model.

7. The sales floor management system as claimed in claim 5, wherein the operations performed by the information processing device include
generating, as the display support information, an image that visualizes a level of appropriateness of the display state of a product.

8. The sales floor management system as claimed in claim 1, further comprising a display device possessed by the user,
wherein the display support information is presented to the user via the display device.

9. The sales floor management system as claimed in claim 8, wherein the display device displays the display support information as a virtual object overlaid on a real space within the user's actual field of view.

10. The sales floor management system as claimed in claim 1, further comprising a robot that performs display work,
wherein the robot is configured to:
acquire, as the display support information, information on a recommended display state of target products from the information processing device; and
perform display work based on the display support information.

11. The sales floor management system as claimed in claim 1, wherein the operations performed by the information processing device include:
generating the display support information based on information on the camera for imaging the sales floor, including the camera's installation position, imaging angle and relative position to a display area to be imaged.

12. A sales floor management method in which an information processing device is caused to perform operations for managing a display state of products on a sales floor of a store based on a captured image acquired from a camera for imaging the sales floor, wherein the operations performed by the information processing device include:
using a product recognition model to recognize products from the captured image;
based on the recognition result, generating, as display support information for supporting display work performed by a user, information on a recommended display state of target products; and
presenting the display support information to the user.

13. A sales floor management method in which an information processing device is caused to perform operations for managing a display state of products on a sales floor of a store based on a captured image acquired from a camera for imaging the sales floor, wherein the operations performed by the information processing device include:
using a product recognition model to recognize products from the captured image;
based on the recognition result, detecting an inappropriate display state of a product;
generating, as display support information for supporting display work performed by a user, information on a position of the product that is in the inappropriate display state; and
presenting the display support information to the user.
